(19) United States
(12) Patent Application Publication
(10) Pub. No.: US 2005/0139805 A1
(43) Pub. Date: Jun. 30, 2005

(54) Dechlorinating tablet and method of manufacture

(76) Inventor: Dale Koster, Belmont, MI (US)

Correspondence Address: Jo Katherine D'Ambrosio;D'Ambrosio & Associates, P.L.L.C., Suite 465, 10260 Westheimer Road, Houston, TX, 77042, US

(21) Appl. No.: 10/975,757

(22) Filed: Oct. 28, 2004

Related U.S. Application Data
(60) Provisional application No. 60/517,958, filed on Nov. 6, 2003.

(51) Int. Cl. C09K 3/00; C01B 17/62; C02F 5/02; C02F 5/08; C02F 5/10; B01D 19/00; C01F 1/00; C01G 1/00; C01C 1/22; C01D 5/14

(52) U.S. Cl. 252/181; 423/519; 252/188.21; 252/175

(57) ABSTRACT

A dehalogenating agent is disclosed that is useful for treating aqueous media. The agent contains at least one sulfite salt, such as sodium sulfite. In the agent, the salt is in mixture with a lubricant, an excipient and a saccharide binder. Then a dry, blended mixture of the agent components is directly compressed to form tablets not only of desirable strength and hardness, but also of desirably controlled dissolution rate.

This application claims the benefit of U.S. Provisional Application No. 60/517,958, filed Nov. 6, 2003.

### FIELD OF THE INVENTION

The invention relates to a tablet usable in the dehalogenation of aqueous fluids. More particularly, the invention relates to a dechlorination agent that is amenable to tablet formation by direct compression.

1. Field of the Invention

The invention relates to a tablet usable in the dehalogenation of aqueous fluids. More particularly, the invention relates to a dechlorination agent that is amenable to tablet formation by direct compression.

2. Description of the Related Art

Chlorine is often used as the disinfectant of choice by water utilities and companies using large quantities of water. Water containing residual chlorine is discharged during emergencies, as well as routine activities such as filter backwash, disinfection of new pipelines and water mains, flushing of water purification systems and the like.

Chlorine is highly toxic to aquatic life and the U.S. Environmental Protection Agency has established water quality criteria for “total residual chlorine” concentrations permissible in receiving waters. The acute toxicity criterion suggests that the chlorine concentration of a receiving stream of water should not exceed a one-hour average chlorine concentration greater than 19 micrograms/liter more than once every three years. The chronic toxicity criterion suggests that the four-day average concentration of chlorine should not exceed 11 micrograms/liter more than once every three years. Thus, most utilities and companies attempt to dechlorinate all chlorinated water before it is released.

Sodium sulfite is a dechlorinating agent widely used by utilities and companies to neutralize chlorine. One of the major reasons sodium sulfite is widely used is that it is available in tablet form. On a weight-to-weight basis, approximately 1.775 parts of sodium sulfite are required to remove one part of chlorine

The use of sodium sulfite tablets is more convenient to store, handle, and apply as compared to solutions or powders. Sodium sulfite tablets are described in U.S. Pat. No. 4,816,177 and are sold as D-Chlor tablets by Severn Trent Water Purification, Inc., Sugarland, Tex. These tablets provide controlled dissolution of sodium sulfite in aqueous media.

Prior to December 2002, the D-Chlor tablets were manufactured from a wet mixture of sodium sulfite, Lubritab (a lubricant) and Explotab (an excipient) and could be used with or without an extra binder. In the method of manufacturing one formulation, sodium sulfite, in an amount ranging from about 60 weight percent to about 65 weight percent, was combined with a binder, casein in dry form. Water, preferably hot water, was then added along with color additives. The mixture was allowed to dry for a period of 3 to 4 hours and then one or more lubricants such as calcium sterate and sterotex were added. The mixture had to dry for a second period of time. The wet mixture of components was compacted under pressure prior to the second drying phase and then dried to form hard, shippable tablets. Because of the affinity to water, the tablets formed under this wet method have a limited shelf life, approximately 3-6 days under high temperatures above 80° F.

It would be desirable to formulate an essentially waterless composition that could be tableted using high-speed, high pressure molding techniques without needing to undergo a separate drying step. It would also be desirable to decrease the friability (or brittleness) of the tablets while increasing their dissolution time in aqueous fluids.

### SUMMARY OF THE INVENTION

A composition has now been formulated which provides the foregoing described desirable characteristics. More particularly, the composition is a mixture of dry, particulate compounds suitable for high speed, high pressure tableting techniques without the need for a separate drying process.

The composition includes a carbohydrate binder, preferably lactose monohydrate, which decreases the friability of the tablet and extends the dissolution time of the tablet in aqueous fluids.

One aspect of the present invention is directed to a dehalogenating agent for extended time release, controlled dissolution in an aqueous media, the agent comprising, in blended and compacted form, a mixture prepared from a dry mix of a plurality of granular solid particulates, the mixture having greater than 80 weight percent of a sulfite salt and greater than 1.0 weight percent of a saccharide binder.

Another aspect of the invention is directed to a dechlorinating agent comprising: a sulfite salt present from about 80 to about 90 weight percent; a lubricant present from about 10 to about 15 weight percent; an excipient present from about 1.5 to about 3.0 weight percent; and a saccharide binder present from about 1.0 to about 3.0 weight percent; whereby direct compression of a mixture of the sulfite salt, the lubricant, the excipient, and the saccharide binder forms a controlled dissolution tablet.

Yet another aspect of the invention is directed to a dechlorinating agent comprising: an alkali metal sulfite salt present at about 83 weight percent; a lubricant present from at about 13 weight percent; an excipient present at about 2.4 weight percent; and a saccharide binder present at about 1.6 weight percent; whereby direct compression of a mixture of the sulfite salt, the lubricant, the excipient, and the saccharide binder forms a controlled dissolution tablet.

Still yet another aspect of the invention is directed to the method of making a dehalogenating agent for extended time release, controlled dissolution in aqueous media, the method comprises: (a) blending a sulfite salt, a lubricant, an excipient, and a saccharide binder to form a blended mixture, wherein each component of the blended mixture is present in a dry particulate form; (b) mixing the blended mixture of dry particulate components for a set time period; and (c) compressing the blended mixture to form a tablet. Since only dry ingredients are used, no drying time is required.

The foregoing has outlined rather broadly several aspects of the present invention in order that the detailed description of the invention that follows may be better understood and thus is not intended to narrow or limit in any manner the appended claims which define the invention. Additional features and advantages of the invention will be described hereinafter which form the subject of the claims of the invention. It should be appreciated by those skilled in the art that the conception and the specific embodiment disclosed might be readily utilized as a basis for modifying the composition or method of manufacture for carrying out the same purposes as the invention. It should be realized by those skilled in the art that such equivalent constructions do not depart from the spirit and scope of the invention as set forth in the appended claims.

### DESCRIPTION OF THE PREFERRED EMBODIMENTS

The dehalogenating agent of the present invention is contemplated for use with any halogen-containing aqueous media in which the sulfite salt is soluble and the saccharide binder is dispersible. More specifically, the dehalogenating agent is a dechlorinating agent useful for neutralizing chlorine in a water stream, potable water, plant effluent, storm water run off, rain water, for example. In formulating the dechlorinating agent, dry ingredients are mixed, compressed into sheets and punched into tablets for ease of application.

The dehalogenating agent is intended for the extended time release, controlled dissolution in an aqueous media. In one aspect, the agent is formulated in a blended and compacted form such as a tablet or pill. The dehalogenating agent is a mixture prepared from mixing a plurality of granular solid particulates, the mixture having greater than 80 weight percent of a sulfite salt and a saccharide binder. It is known that the sulfite salts can react with chlorine, or other halogens, in aqueous fluids. It is most economical to use an alkali metal sulfite or a mixture of alkali metal sulfites, e.g., the potassium and sodium alkali metal sulfites. Preferably, sodium sulfite is employed.

For preparation of the dehalogenating agent, the sulfite salt is used as a free-flowing particulate substance, e.g., in powder or flake form. Although such particulates should advantageously be dry to the touch for best blending of the agent, it is understood that they may contain some small amounts of moisture, such as water of hydration or hygroscopic moisture content. It is important to note that no water is added to the sulfite salt during the manufacture of the tablets of this invention. Particulate sulfite salts are used, so long as they are free-flowing they can be readily blended in the formulation of the treating agent. The mixture is a dry mixture, thereby eliminating the wet stage of previous methods of producing the dechlorination tablet.

It is advantageous for the free-flowing particulate sulfite salt to have an average particle size within the range of from about 45 microns to about 250 microns. It is also most desirable that such particulate salt have particles more finely divided than about 420 microns (40 mesh) and for best blending be essentially free of fines and dust, e.g., be essentially free of particles having size below about 45 microns (about 325 mesh). Preferably, the sulfite salt will have a particle size distribution such that about 30-50 weight percent of particles are more finely-divided than about 150 microns and about 10-30 weight percent are more finely-divided than about 75 microns. Mesh as used herein is U.S. Sieve Series.

The sulfite salt is preferably blended with at least one lubricant, at least one excipient and at least one binder to form the dehalogenating agent. The sulfite salt makes up at least 80% of the dehalogenating, or more specifically the dechlorinating, agent. In one embodiment, a dechlorinating agent comprises a sulfite salt present from about 80 to about 90 weight percent; a lubricant present from about 10 to about 15 weight percent; an excipient present from about 1.5 to about 3.0 weight percent; and a saccharide binder present from about 1.0 to about 3.0 weight percent. Direct compression of the mixture of the sulfite salt, the lubricant, the excipient, and the saccharide binder forms a controlled dissolution tablet.

In another embodiment of the dechlorinating agent, the agent comprises an alkali metal sulfite salt present at about 83 weight percent; a lubricant present at about 13 weight percent; an excipient present at about 2.4 weight percent; and a saccharide binder present at about 1.6 weight percent.

In a further embodiment of the dechlorinating agent, the agent comprises a sodium sulfite salt present at about 83 weight percent; a hydrogenated vegetable oil present at about 13 weight percent; a sodium starch glycolate present at about 2.4 weight percent; and a lactose monohydrate present at about 1.6 weight percent. The direct compression of the mixture of the sulfite salt, the hydrogenated vegetable oil, the sodium starch glycolate, and the lactose monohydrate forms a controlled dissolution tablet.

At least one lubricant is included in the dehalogenating, or dechlorinating, agent of the present invention. A variety of lubricants are useful in the present invention, including fatty acid soaps, animal fats and plant oils. The preferred lubricant in the present invention is Lubritab sold by JRS Pharma, Patterson, N.Y. Lubritab is a hydrogenated vegetable oil, Type I, NF. Lubritab makes an efficient lubricant for the present invention because it is less chemically reactive than most common lubricants and it serves as an auxiliary dry binder and controlled release matrix. Lubritab is available in a free-flowing particulate form and is added to the dehalogenating agent from about 10 to about 15 weight percent of the agent.

The dehalogenating agent will also include at least one excipient. A variety of excipients may be used in the dehalogenating agent, with a preferred excipient being a cross-linked, low substituted carboxymethyl ether of potato starch sold under the name Explotab by JRS Pharma, Patterson, N.Y. Explotab is a sodium starch glycolate and is sold as a free-flowing particulate material.

At least one binder is included in the dehalogenating agent. Although use of Lubritab as a lubricant also serves as an auxiliary binder, the use of a saccharide binder such as lactose was found to be surprisingly efficient at decreasing the friability of the tablets and increasing the dissolution time of the tablet in aqueous fluids. For example, the inclusion of lactose monohydrate in the agent from about a 1.0 to about a 2.0 weight percent of the dehalogenating agent reduced the friability of the tableted dehalogenating agent about 50 percent. This is an important factor in that the shelf life of the tablets is doubled and the number of tablets that have to be discarded because of crumbling is drastically reduced. Furthermore, the dissolution time of the tablets in aqueous fluids is also increased. However, if too much lactose is added to the dehalogenating agent, the resulting dehalogenating tablets exhibit a decrease in dissolution time in aqueous fluids.

A method of making a dehalogenating agent for extended time release, controlled dissolution in aqueous media comprises blending a sulfite salt, a lubricant, an excipient, and a saccharide binder to form a blended mixture. Each component of the blended mixture is present in a dry particulate form. The actual blending operation for the dry free-flowing particulate ingredients of the agent is handled by standard blending processes such as the use of blending equipment like a twin-shell mixer or ribbon blender. The blended mixture of dry particulate components are mixed for a set time period at ambient temperature. Preferably, the mixing time is inversely proportional to the ambient temperature. In one embodiment, the blended mixture of material is mixed for 7 minutes at temperatures ranging from about 55° F. to about 70° F., depending on atmospheric conditions. Alternatively, the blended mixture is mixed for 5 minutes at temperatures lower than 55° F., again the temperature is dependent on atmospheric conditions.

The blended materials are compacted into tablets using in high pressure compression techniques. Pressure in compaction can be on the order of from about 10 KPSI to about 100 KPSI. The tablets will exhibit the desirable strength and hardness, e.g., freedom from chipping as well as dusting.

Following are two test examples comparing the prior art with the present invention. Example 3 shows one way in which the invention has been practiced but should not be construed as limiting the invention.

### TEST EXAMPLES

### Test Example 1

### Prior Art (Wet Mixture Formed Sodium Sulfite Tablet)

| INGREDIENTS | WEIGHT | | COMPANY |
|---|---|---|---|
| 1. SODIUM SULFITE | 200 # | −74.6% | EXCELTEC |
| 2. CASEIN | 12 # | 4.5% | EXCELTEC |
| 3. WATER | 50 # | 18.7% | TABLETTING |
| 4. BLUE 9RN | 4 gm | trace | KEYSTONE |
| 5. YELLOW 8BR | 20 gm | trace | KEYSTONE |
| 6. CALCIUM STERATE | 4.5 # | 1.7% | VAN WATERS |
| 7. STEROTEX | 1.5 # | 0.5% | KARLSHAMN'S |

To Form Tablet:

1. Mix #1—Combine ingredients 2, 3, 4, and 5.

2. Mix #3—Combine Mix #1 and ingredient 1.

3. Dry then granulate and add ingredients 6 and 7, mix. Dry final mixture

4. Punch tablets.

Procedure for Testing:

Weigh tablets. Dissolve 3 tablets in water for six hours by flowing water over tablets at a rate of 2.9 gal/hr. Remove from tester, dry overnight. Weight tablets.

Results:

| | |
|---|---|
| Average tablet weight: | 143.33 gm |
| Water temperature: | 59 degrees |
| Dissolve rate: | 15.8 gm/hr |
| Moisture percentage: | 13% |
| Flow rate: | 2.9 gpm |

### Test Example 2

### Dry Sulfite Tablet of Present Invention

| INGREDIENTS | WEIGHT | | COMPANY |
|---|---|---|---|
| 1. SODIUM SULFITE | 250 # | 83.0% | EXCELTEC |
| 2. LUBRITAB (LUBRICANT) | 39 # 2 OZ. | 13.0% | PENWEST |
| | | | PHARM. |
| 3. EXPLOTAB (EXCIPENT) | 12 # 22 gm | 4.0% | PENWEST |
| | | | PHARM. |
| 4. BLUE #1 (LAKE) | 20 gm | trace | GLOBAL |
| 5. YELLOW #5 (LAKE) | 20 gm | trace | GLOBAL |

To Form Tablet: Mix numbers 1 through 5 and punch.
Procedure for Testing:

Weigh tablets. Dissolve 3 tablets in water for six hours by flowing water over tablets at a rate of 2.9 gal/hr. Remove from tester, dry overnight. Weight tablets.

Results:

| | |
|---|---|
| Average tablet weight: | 147.33 gm |
| Water Temperature: | 44 degrees |
| Moisture percentage | 0-1% |
| Dissolve Rate: | 5 gm/hr |
| Flow rate: | 2.9 gpm |

### Example 3

### Preparation of a Water Dechlorinating Agent According to the Method of this Invention

For preparing a water dechlorinating agent there is first blended together about 83 weight parts of sodium sulfite with about 13 weight parts of Lubritab, about 2.4 weight parts of Explotab and about 1.6 weight parts of lactose monohydrate. These materials are blended together in a ribbon blender. Discrete amounts of the resulting blended material are then subjected to direct high pressure compaction to prepare dechlorinating tablets that are 145 grams±5 grams. The dissolution rate of the tablets in running water is 2-6 grams per hour from about 40-60° F.

Tablets made according to this method will have a shelf life of 4 to 6 months when exposed to temperatures as high as 90° F.

Although the present invention and its advantages have been described in detail, it should be understood that various changes, substitutions and alterations can be made herein without departing from the spirit and scope of the invention as defined by the appended claims.

1. A dehalogenating agent for extended time release, controlled dissolution in an aqueous media, said agent comprising, in blended and compacted form a mixture prepared from mixing a plurality of granular solid particulates, the mixture having greater than 80 weight percent of a sulfite salt and a saccharide binder.

2. The agent of claim 1, wherein the sulfite is an alkali metal sulfite or a mixture of alkali metal sulfites.

3. The agent of claim 1, wherein the sulfite salt is sodium sulfite.

4. The agent of claim 1, wherein the saccharide binder is present in the mixture at greater than 1.0 weight percent

5. The agent of claim 1, wherein the saccharide binder is a polysaccharide.

6. The agent of claim 1, wherein the saccharide is lactose.

7. The agent of claim 1, wherein the mixture further comprises a lubricant present in the mixture at a concentration greater than 10 weight percent.

8. The agent of claim 7, wherein the lubricant is selected from the group consisting of fatty acid soaps, animal fats, plant oils and mixtures thereof.

9. The agent of claim 1, wherein the lubricant is a hydrogenated vegetable oil.

10. The agent of claim 1, wherein the mixture further comprises an excipient.

11. The agent of claim 10, wherein the excipient is a modified starch.

12. The agent of claim 10, wherein the excipient is a sodium starch glycolate.

13. The agent of claim 1, wherein the sulfite salt is a free-flowing particulate substance having an average particle size within the range of from about 75 microns to about 250 microns.

14. The agent of claim 1, wherein the blended and compacted form is a tablet.

15. A dechlorinating agent comprising:
(a) a sulfite salt present from about 80 to about 90 weight percent;
(b) a lubricant present from about 10 to about 15 weight percent;
(c) an excipient present from about 1.5 to about 3.0 weight percent; and
(d) a saccharide binder present from about 1.0 to about 3.0 weight percent;
whereby direct compression of a mixture of the sulfite salt, the lubricant, the excipient, and the saccharide binder forms a controlled dissolution tablet.

16. The agent of claim 1, wherein the sulfite is an alkali metal sulfite or a mixture of alkali metal sulfites.

17. The agent of claim 16, wherein the sulfite salt is sodium sulfite.

18. The agent of claim 15, wherein the lubricant is selected from the group consisting of fatty acid soaps, animal fats, plant oils and mixtures thereof.

19. The agent of claim 15, wherein the saccharide binder is a disaccharide.

20. The agent of claim 15, wherein the saccharide is lactose.

21. A dechlorinating agent comprising:
(a) an alkali metal sulfite salt present at about 83 weight percent;
(b) a lubricant present at about 13 weight percent;
(c) an excipient present at about 2.4 weight percent; and
(d) a saccharide binder present at about 1.6 weight percent;
whereby direct compression of a mixture of the sulfite salt, the lubricant, the excipient, and the saccharide binder forms a controlled dissolution tablet.

22. The agent of claim 21, wherein the sulfite salt is sodium sulfite.

23. The agent of claim 21, wherein the saccharide binder is lactose.

24. The agent of claim 21, wherein the excipient is a modified starch.

25. The agent of claim 21, wherein the lubricant is a vegetable oil.

26. A dechlorinating agent comprising:
(a) a sodium sulfite salt present at about 83 weight percent;
(e) a hydrogenated vegetable oil present at about 13 weight percent;
(f) a sodium starch glycolate present at about 2.4 weight percent; and
(g) a lactose monohydrate present at about 1.6 weight percent;
whereby direct compression of a mixture of the sulfite salt, the hydrogenated vegetable oil, the sodium starch glycolate, and the lactose monohydrate forms a controlled dissolution tablet.

27. A method of making a dehalogenating agent for extended time release, controlled dissolution in aqueous media, the method comprises:
(a) blending a sulfite salt, a lubricant, an excipient, and a saccharide binder to form a blended mixture, wherein each component of the blended mixture is present in a dry particulate form;
(b) mixing the blended mixture of dry particulate components for a set time period at ambient temperature; and
(c) compressing the blended mixture to form a tablet.

28. The method of claim 27, wherein said sulfite salt is present at greater than 80 weight percent of the blended mixture and the saccharide binder is present at greater than 1.0 weight percent of the blended mixture.

29. The method of claim 27, wherein the lubricant is selected from the group consisting of fatty acid soaps, animal fats, plant oils and mixtures thereof

30. The method of claim 27, wherein the sulfite salt is capable of reacting with chlorine, bromine or iodine in aqueous media.

31. The agent of claim 27, wherein the mixing time is inversely proportional to the ambient temperature.

32. The agent of claim 27, wherein the mixing time is 5 minutes when the ambient temperature is less than 55° F.

33. The agent of claim 27, wherein the mixing time is 7 minutes when the ambient temperature is greater than 55° F.

34. The method of claim 27, wherein the blended mixture is compressed at a pressure within the range from about 10 KPSI to about 100 KPSI to prepare the tablet.
